(19) United States
(12) Patent Application Publication
(10) Pub. No.: US 2010/0057846 A1
(43) Pub. Date: Mar. 4, 2010

(54) Image processing method, apparatus and system

(75) Inventor: Jinfeng Zhang, Hangzhou (CN)

Correspondence Address: VAN PELT, YI & JAMES LLP, 10050 N. FOOTHILL BLVD #200, CUPERTINO, CA, 95014, US

(73) Assignee: Alibaba Group Holding Limited

(21) Appl. No.: 12/583,443

(22) Filed: Aug. 20, 2009

(30) Foreign Application Priority Data
Aug. 29, 2008 (CN) 200810135527.X

(51) Int. Cl. G06F 15/16

(52) U.S. Cl. 709/203; 709/219

(57) ABSTRACT

The invention provides a method, an apparatus and a system for image processing in a network environment such as the Internet. The method includes receiving an image access request sent by a user, forwarding the image access request to a real-time image processor, receiving an image returned by the real-time image processor for the user to use, the image being obtained by the real-time image processor processing the original image according to the image access request. According to the embodiments of the invention, users can obtain images of interest in real time, user demand is well met, and user satisfaction is improved.

### CROSS REFERENCE TO OTHER APPLICATIONS

This application claims priority to the People's Republic of China Patent Application No. 200810135527.X entitled IMAGE PROCESSING METHOD, APPARATUS AND SYSTEM filed on Aug. 29, 2008 which is incorporated herein by reference for all purposes.

### FIELD OF THE INVENTION

The present application relates to the field of network technologies, and in particular to a method, an apparatus and a system for image processing in the Internet.

### BACKGROUND OF THE INVENTION

With the growth of Internet, particularly with the growth of e-business websites and photo sharing websites, requirements for images have dramatically increased. Individual websites may need to provide images in different sizes, resolutions and/or formats due to different displaying needs and bandwidth limitations. For example, in some online shopping websites, 80×80 pixels sized product images are normally provided as thumbnails along product lists, and 200×200 pixels sized product images or higher resolution product images are provided if a customer wants to examine a certain product more closely. In other services, images having additional specifications may need to be provided. Some services may also need images to be further processed, for example, watermarked with a company logo or a trademark.

An existing solution to the above problem is to pre-process the images to different sets of specifications, such as pre-scaling the images to different sizes, to produce different copies of the same images in the different sets of specifications and store the copies of the images in one or more databases to meet different application needs. An alternative solution is to provide single copies of the same images having one set of specifications as the original images, users can download the original images to a client device and adjust the images to other specifications according to their individual needs.

In some situations, if images of multiple sets of specifications are pre-stored, a large amount of files may need to be generated and large amount of storage space may be required for storing these files. If a service demands images to have a new size or resolution, hundreds of millions of files may need to be created and processed in order to generate these new images, which is not flexible and inefficient. On the other hand if only original images of one size are provided, the original images may have to be of high quality to guarantee the usability of the images, and a large bandwidth may be required when images are downloaded to a client device. Furthermore, web pages that display multiple high resolution product images may be difficult to open, making their real-time performances poor.

### BRIEF DESCRIPTION OF THE DRAWINGS

Various embodiments of the invention are disclosed in the following detailed description and the accompanying drawings.

FIG. 1 illustrates a flow chart of an embodiment of a method for image processing in a network environment.

FIG. 2 illustrates a flow chart of an embodiment of a method for image processing in a network environment.

FIG. 3 is a diagram of an embodiment of a system for image processing in a network environment.

FIG. 4 is a diagram of an embodiment of a system for image processing in a network environment.

FIG. 5 is a diagram of an embodiment of a system for image processing in a network environment.

### DETAILED DESCRIPTION

The invention can be implemented in numerous ways, including as a process, an apparatus, a system, a composition of matter, a computer program product embodied on a computer readable storage medium, and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To overcome the above-mentioned problems, various embodiments of a method, an apparatus and a system for image processing in a network environment such as the Internet are provided herein. The various embodiments can be used to meet various requirements for images and for producing images with different sets of specifications in a network environment and in real time.

An example method for image processing over a network environment such as the Internet includes receiving at a local node, such as at a Content Delivery Network (CDN) node, an image access request sent by a user; forwarding the image access request to a real-time image processor if an image requested by the image access request is not stored locally such as locally at the CDN node; and receiving an image returned by the real-time image processor for the user to use, the image being obtained by the real-time image processor processing an original image according to the image access request. In some embodiments, the method further includes storing the received image locally, such as locally at the CDN node. Locally storing the received image may include storing in a local storage on the CDN node or storing in a storage that is locally accessible by the CDN node. In some embodiments, the method further includes performing maintenance on the locally stored image. The maintenance may for example include deleting an image with an accessing frequency lower than a predefined threshold according to an accessing frequency of the locally stored image.

In some embodiments, the maintenance on the locally stored images such as images stored locally in a CDN node particularly includes performing the maintenance periodically. In some embodiments, the maintenance on the locally stored images may include performing the maintenance at a CDN node if an available local storage capacity is lower than a predefined threshold capacity. In some embodiments, in the case that the image requested by the image access request is not stored in a local storage, the image access request is forwarded, for example by an image server, to the real-time image processor. In some embodiments, the case in which the image requested by the image access request is not stored locally is the case in which the image requested by the image access request is not the original image. For example, the requested image may be an image in a different size, resolution, and/or format than the original image.

An example CDN node implementing image processing in a network environment such as the Internet includes the following components: a network interface configured to send and receive network traffic associated with the CDN node; a processor configured to receive an image access request sent by a user, forward the image access request to a real-time image processor if the CDN node does not have an image requested by the image access request, receive an image returned by the real-time image processor for the user to use, the image being obtained by the real-time image processor processing an original image according to the image access request, and send the image conforming with the image access request to the user; and a memory coupled to the processor configured to provide the processor with instructions. In some embodiments, the processor of the CDN node is further configured to store the image received by the second receiving unit. In some embodiments, the processor of the CDN node is further configured to perform maintenance on the image stored in the CDN node, the maintenance may include deleting an image with an accessing frequency lower than a predefined threshold according to an accessing frequency of the image stored in the CDN node.

An example real-time image processor implementing image processing in a network environment such as the Internet includes a network interface configured to send and receive network traffic associated with the real-time image processor; a processor configured to receive an image access request of a user, process an original image according to the image access request received by the receiving unit, and send an image resulting from the processing of the processing unit to a CDN node; and a memory coupled to the processor configured to provide the processor with instructions.

An example real-time image processing system for implementing image processing in a network environment such as the Internet includes: a CDN node, a real-time image processor, and an image storage center. The CDN node is configured to, after receiving an image access request sent by a user, send an image conforming with the image access request to the user if the CDN node has the image requested by the image access request; forward the image access request to a real-time image processor if the CDN node does not have the image requested by the image access request; receive an image returned by the real-time image processor, the image being obtained by the real-time image processor processing an original image according to the image access request; and send the received image conforming with the image access request to the user. The real-time image processor is configured to receive the image access request of the user, process the original image according to the received image access request, and send a resultant image to the CDN node after processing. The image storage center is configured to store the original image. In some embodiments, the system further includes an imaging server, the imaging server is configured to receive the image access request forwarded by the CDN node, and determine whether an image requested by the image access request is the original image. If the image requested is determined to be the original image, return the original image stored at the image storage center to the CDN node; otherwise, forward the image access request to the real-time image processor.

As can be seen, in the various embodiments of the invention, a local node such as a CDN node receives an image access request sent from a user, forwards the image access request to a real-time image processor if the CDN node does not have an image requested by the image access request; the CDN node receives an image returned by the real-time image processor for the user to use, the image is obtained by the real-time image processor processing an original image according to the image access request. According to the embodiments of the invention, users can obtain images of interest in real time, user demand is well met, and user satisfaction is improved.

Various embodiments of a method, an apparatus and a system for image processing in a network environment such as the Internet are described in more detail below with reference to the accompanying figures.

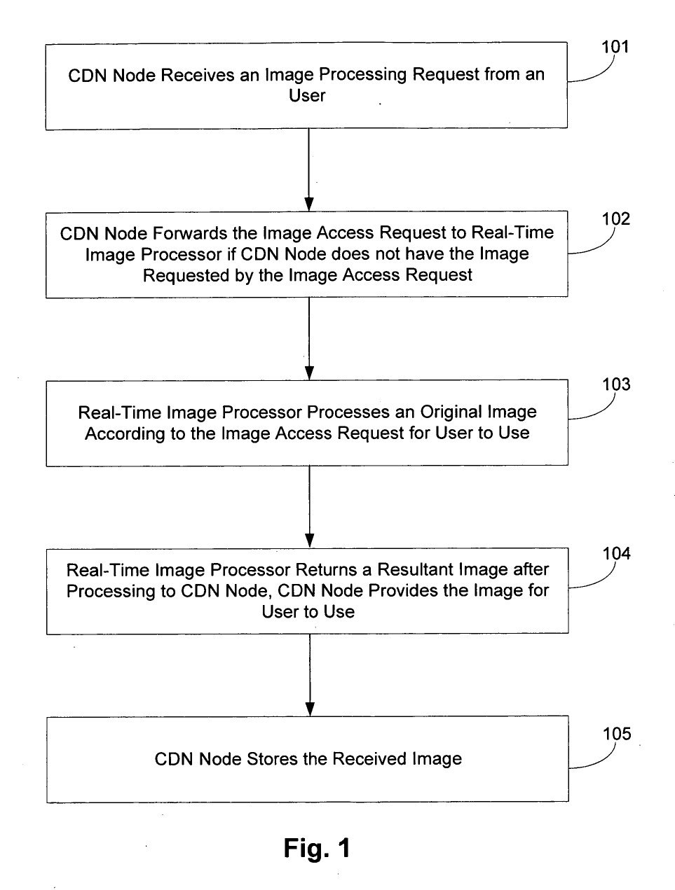

Referring to FIG. 1, in the first embodiment of the invention, the method provided by the embodiment includes the following: At 101, a Content Delivery Network (CDN) node receives an image access request sent by a user. The image access request carries a main filename and an auxiliary filename of an image. The main filename corresponds to an original image stored in an imaging server. The auxiliary filename represents a requirement for the image, for example, a requirement for one or more specifications of the image, or a special processing requirement for the image, such as watermarking.

In some embodiments, before step 101, the method further includes: directing the image access request to an optimal CDN node from the user. Such directing is performed through DNS resolution, for example, by setting DNS, all requests from Beijing for a certain domain name are resolved to an IP address of a CDN node at Beijing. This is a normal DNS resolution method in the Internet. The optimal CDN node from the user is a node manually set based on network quality and traffic analysis of different locations. For example, users at Beijing city and Hebei city can all be directed to a node at Beijing city.

Through the use of near client caching of image data by the widely used CDN nodes, the user access speed can be effectively improved, data traffic is distributed, and workload on the imaging server is diverted.

Step 102: the image access request is forwarded to a real-time image processor, if the CDN node does not have the image requested by the image access request. Step 103: the real-time image processor obtains the original image from an image storage center according to the image access request, and processes the original image. Step 104: the real-time image processor returns to the CDN node an image resulting from the processing, and the CDN node provides the image for the user to use.

In the embodiment, only one original image is stored in an imaging server, and images of any other sizes can be calculated according to a parameter of the access request by the real-time image processor invoking an image processing algorithm. The amount of images to be stored is significantly reduced, and the flexibility to provide images of any type is greatly improved. With the method provided by the embodiment, original images can be processed according to users' actual needs in real time, and users can obtain images that they want.

In some embodiments, after step 104, the method further includes Step 105: the CDN node stores the received image. The CDN node stores the received image, therefore, if a user requests for this image again, the image can be issued directly to the user without requesting the real-time image processor to carry out further image processing, time and network resources can be saved, and efficiency is further improved.

In some embodiments, the forwarding of the image access request to the real-time image processor includes: the CDN node forwards the image access request to the real-time image processor via an imaging server. The step of the CDN node forwarding the image access request to the real-time image processor via the imaging server includes: the CDN node forwards the image access request to the imaging server; if the one requested by the image access request is the original image, the imaging server returns the original image directly to the CDN node; otherwise, the imaging server forwards the image access request to the real-time image processor. In this embodiment, before the CDN node forwards the image access request to the real-time image processor, the image access request is forwarded to the imaging server, which determines whether the one requested by the image access request is the original image, and if so, the original image is returned directly; otherwise, the image access request is forwarded to the real-time image processor to process. The operation procedure of the real-time image processor is thereby reduced, and the overall operation efficiency is improved. In addition, because images of each specification can be obtained in real time by the real-time image processing invoking an image processing algorithm, permanent storage space is thus saved.

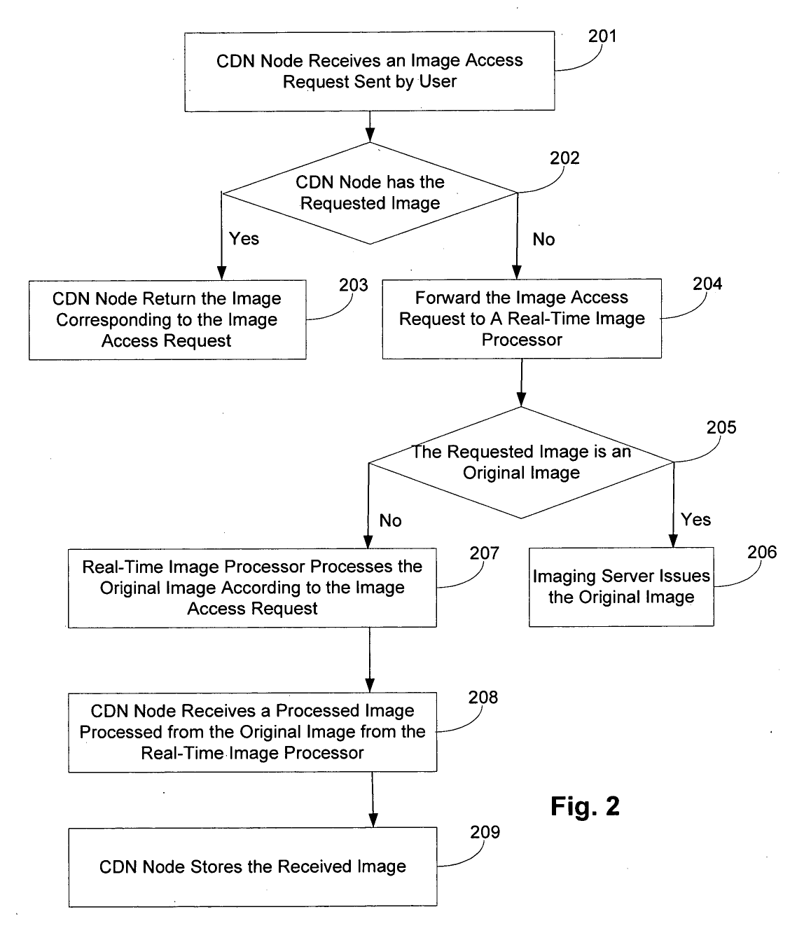

In the second embodiment of the invention, a method for image processing in the Internet is further described. Referring to FIG. 2, the method includes: Step 201: a CDN node receives an image access request sent by a user. Step 202: the CDN node checks whether itself has an image corresponding to the image access request, and if so, go to step 203; otherwise, go to step 204. Step 203: the image corresponding to the image access request is returned. Step 204: the image access request is forwarded to a real-time image processor. Step 205: the real-time image processor determines whether the image requested by the image access request is an original image, and if so, go to step 206; otherwise, go to step 207. Step 206: the real-time image processor issues the original image. Step 207: the real-time image processor processes the original image according to the image access request, and returns an image resulting from the processing.

In some embodiments, step 207 further includes: the real-time image processor performs a regulation process on the original image, which regulates the original images into a format readable for browsers. By the regulation of the original image, malicious codes under the pretence of an image can be prevented from uploading. In some embodiments, the process includes: resizing the original image into a certain size; or, watermarking the original image. In some embodiments, the process can be customized by the user and performed according to the user's actual needs, thereby achieving a good extendibility.

Step 208: the CDN node receives the image resulting from the processing of the real-time image processor for the user to use. Step 209: the CDN node stores the received image. In some embodiments, after step 209, the method further includes: performing maintenance on the image stored in the CDN node, which includes: deleting an image with an accessing frequency lower than a predefined threshold according to an accessing frequency of the image stored in the CDN node. In some embodiments, the maintenance is performed regularly, or the maintenance is performed if an available storage capacity of the CDN node is lower than a predefined threshold capacity. The storage capacity of the CDN node may be limited, therefore images stored in the CDN node may have to be updated constantly, by for example deleting images that are infrequently accessed, to provide a more efficient service for users.

With the method provided by the embodiment, the CDN node determines whether itself has the image requested by the user stored in its local storage, and if itself can meet the request, that is the requested images is found stored in its local storage, the CDN node returns the image requested by the user; otherwise if itself cannot meet the request, the CDN node forwards the request of the user to the real-time image processor. The real-time image processor provides the image of interest for the user according to the user's request in real time, thereby fulfilling the user's needs.

In some embodiments, the CDN node caches the image obtained from the real-time image processor. Therefore, if a user requests for this image again, the CDN node can process the request directly without requesting the real-time image processor. This saves the time for the real-time image processor to process again and free up network resources, thereby improving the efficiency.

In some embodiments, the CDN node processes the stored images according to its storage capacity and/or accessing frequencies of the stored images, which further ensures the adaptability of the CDN node for network requirement, and improves operation efficiency of the CDN node.

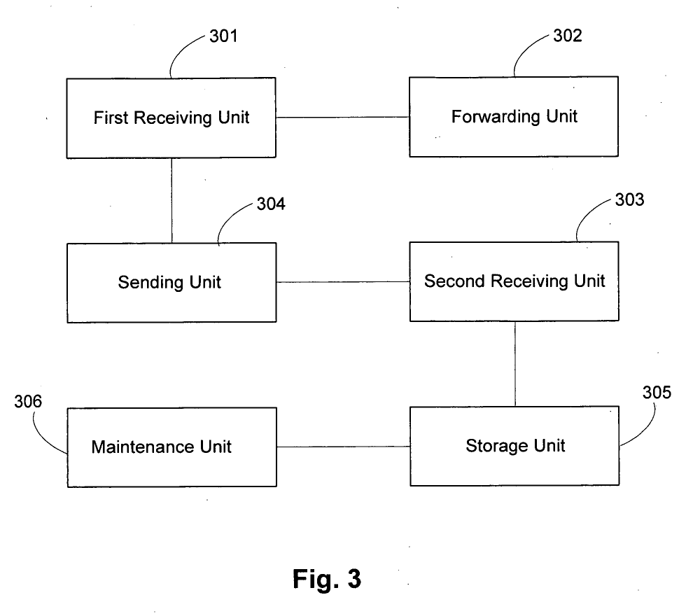

The third embodiment corresponds to the methods provided by the embodiments of the invention. Referring to FIG. 3, a CDN node implementing image processing in the Internet is provided by the embodiment, including: a first receiving unit 301, adapted to receive an image access request sent by a user; a forwarding unit 302, adapted to forward the image access request to a real-time image processor, if the CDN node does not have an image requested by the image access request; a second receiving unit 303, adapted to receive an image returned by the real-time image processor for the user to use, the image being obtained by the real-time image processor processing an original image according to the image access request; a sending unit 304, adapted to send the image conforming with the image access request to the user.

In some embodiments, the apparatus further includes: a storage unit 305, adapted to store the image received by the second receiving unit 303. In some embodiments, the apparatus further includes: a maintenance unit 306, adapted to perform maintenance on the image stored in the CDN node. The maintenance includes: deleting an image with an accessing frequency lower than a predefined threshold according to an accessing frequency of the image stored in the CDN node.

The operation procedure of the apparatus of FIG. 3 is as follows: after the first receiving unit 301 receives the image access request sent by the user, if the CDN node has the image requested by the image access request, the sending unit 304 sends an image conforming with the image access request to the user; if the CDN node does not have the image requested by the image access request, the forwarding unit 302 forwards the image access request to the real-time image processor, the second receiving unit 303 receives an image returned by the real-time image processor which is obtained by the real-time image processor processing an original image according to the image access request, the sending unit 304 sends the image conforming with the image access request to the user, the storage unit 305 stores the image received by the second receiving unit 303, and the maintenance unit 306 performs maintenance on the image stored in the CDN node.

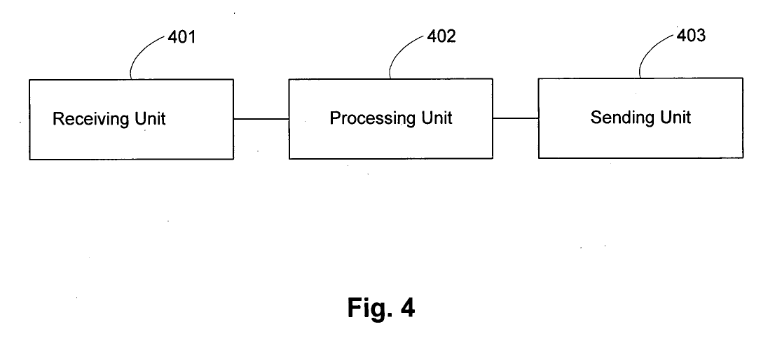

Now refer to FIG. 4. The fourth embodiment of the invention provides a real-time image processor implementing image processing in the Internet, including: a receiving unit 401, adapted to receive an image access request of a user; a processing unit 402, adapted to process an original image according to the image access request received by the receiving unit 401, the processing including resizing the original image into a certain size; or watermarking the original image; a sending unit 403, adapted to send an image resulting from the processing of the processing unit 402 to a CDN node.

The operation procedure of the apparatus of FIG. 4 is: after the processing unit 402 process the original image according to the image access request received by the receiving unit 401, the sending unit 403 sends an image resulting from the processing of the processing unit 402 to a CDN node.

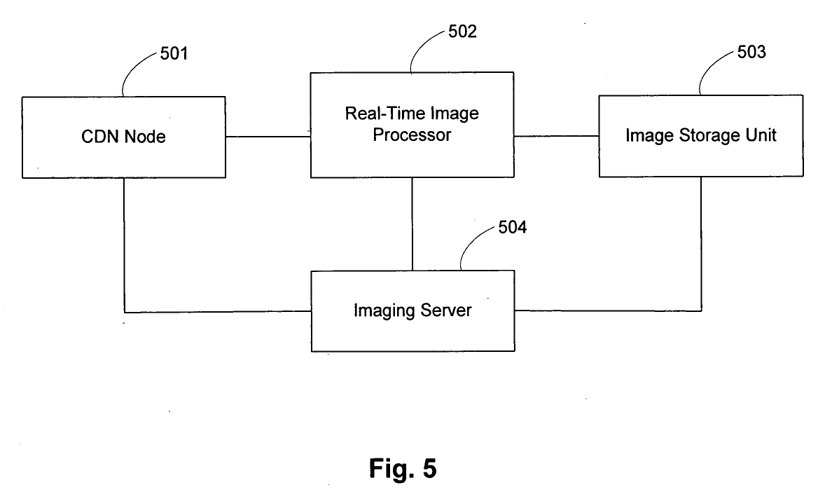

Now refer to FIG. 5. The fifth embodiment of the invention provides a real-time image processing system for implementing image processing in the Internet, including: a CDN node 501, adapted to, after receiving an image access request sent by a user, send an image conforming with the image access request to the user if itself has the image requested by the image access request; forward the image access request to a real-time image processor if itself does not have the image requested by the image access request; receive an image returned by the real-time image processor which is obtained by the real-time image processor processing an original image according to the image access request; and send the received image conforming with the image access request to the user; a real-time image processor 502, adapted to receive the image access request of the user, process the original image obtained from an image storage center 503 according to the received image access request, and send a resultant image to the CDN node after processing; the image storage center 503, adapted to store the original image.

In some embodiments, the system of FIG. 5 further includes: an imaging server 504, adapted to receive the image access request forwarded by the CDN node, and determine whether an image requested by the image access request is the original image, and if so, return the original image stored at the image storage center 503 to the CDN node; otherwise, forward the image access request to the real-time image processor 502.

Various embodiments of the invention are described above. It should be noted that, alternations and modifications can be made by those skilled in the art without departing from the principle of the invention. These alternations and modifications should be included in the scope of the invention.

It should be noted that the network may include various types of telecommunications networks, such as personal area network, local area network (LAN), wide area network (WAN), virtual private network, Intranet, Extranet, Internet, wireless network, land phone network, and wireless phone network.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for image processing in a network environment, comprising:
receiving an image access request sent by a user;
determining whether an image requested by the image access request is found locally;
forwarding the image access request to a real-time image processor, in the event that an image requested by the image access request is not found locally; and
receiving an image returned by the real-time image processor;
sending the image returned by the real-time image processor to the user;
wherein the image is obtained from the real-time image processor, which processes an original image according to the image access request.

2. The method according to claim 1, further comprising storing the received image locally.

3. The method according to claim 2, further comprising performing maintenance on the is locally stored image, the maintenance comprising deleting an image with an accessing frequency lower than a predefined threshold according to an accessing frequency of the locally stored image.

4. The method according to claim 3, wherein the maintenance on the locally stored image comprises performing the maintenance periodically.

5. The method according claim 3, wherein the maintenance on the locally stored image comprises performing the maintenance on the locally stored image if an available local storage capacity is lower than a predefined threshold capacity.

6. The method according to claim 1, wherein in the event that the image requested by the image access request is not stored locally, the image access request is forwarded by an imaging server to the real-time image processor.

7. The method according to claim 1, wherein in the event that the image requested by the image access request is not stored locally, the image requested by the image access request is not the original image.

8. A Content Delivery Network (CDN) node implementing image processing in a network environment, comprising:
a network interface configured to send and receive network traffic associated with the CDN node;
a processor configured to:
receive an image access request sent by a user;
forward the image access request to a real-time image processor, if the CDN node does not have an image requested by the image access request;
receive an image returned by the real-time image processor for the user to use, the image being obtained by the real-time image processor processing an original image according to the image access request;
send the image conforming with the image access request to the user; and
a memory coupled to the processor, configured to provide the processor with instructions.

9. The apparatus according to claim 8, the processor is further configured to store the image received by the second receiving unit.

10. The apparatus according to claim 9, the processor is further configured to perform maintenance on the image stored in the CDN node, the maintenance comprising deleting an image with an accessing frequency lower than a predefined threshold according to an accessing frequency of the image stored in the CDN node.

11. A real-time image processor implementing image processing in a network environment, comprising:
a network interface configured to send and receive network traffic associated with the real-time image processor;
a processor configured to:
receive an image access request of a user;
process an original image according to the image access request received by the receiving unit; and
send an image resulting from the processing of the processing unit to a Content Delivery Network (CDN) node;
a memory coupled to the processor, configured to provide the processor with instructions.

12. A real-time image processing system for implementing image processing in a network environment, comprising:
a Content Delivery Network (CDN) node, configured to, after receiving an image access request sent by a user, send an image conforming with the image access request to the user if the CDN node has the image requested by the image access request; forward the image access request to a real-time image processor if the CDN node does not have the image requested by the image access request; receive an image returned by the real-time image processor, the image being obtained by the real-time image processor processing an original image according to the image access request; and send the received image conforming with the image access request to the user;
the real-time image processor, configured to receive the image access request of the user, process the original image according to the received image access request, and send a resultant image to the CDN node after processing; and
an image storage center, configured to store the original image.

13. The system according to claim 12, further comprising:
an imaging server configured to:
receive the image access request forwarded by the CDN node;
determine whether an image requested by the image access request is the original image; and
return the original image stored at the image storage center to the CDN node if the image requested is the original image.

14. The system according to claim 12, the imaging server is further configured to forward the image access request to the real-time image processor if the image requested is not the original image.

15. The system according to claim 12, wherein the image storage center is locally accessible by the CDN node.
